(19) United States
(12) Patent Application Publication
(10) Pub. No.: US 2009/0327103 A1
(43) Pub. Date: Dec. 31, 2009

(54) METHODS AND SYSTEMS OF MAINTAINING AN INVENTORY LEVEL IN A PRODUCTION ENVIRONMENT

(75) Inventors: John C. Handley, Fairport, NY (US); Bo Hu, Pittsford, NY (US)

Correspondence Address: PEPPER HAMILTON LLP, 500 GRANT STREET, ONE MELLON CENTER, 50TH FLOOR, PITTSBURGH, PA, 15219, US

(73) Assignee: XEROX CORPORATION, Norwalk, CT (US)

(21) Appl. No.: 12/146,658

(22) Filed: Jun. 26, 2008

(51) Int. Cl. G06Q 10/00

(52) U.S. Cl. 705/28

(57) ABSTRACT

A method of maintaining an inventory level of a consumable in a production environment may include monitoring an inventory position associated with a consumable in a production environment, and, based on the monitoring, identifying a plurality of window sets. Each window set may include a plurality of windows, and each window may include a portion of a historic demand distribution associated with the consumable and corresponds to a total inventory management cost. The method may also include selecting, from the plurality of window sets, the window set having the window corresponding to a lowest total inventory management cost. A lower inventory threshold level for the consumable and an upper inventory threshold level for the consumable may be automatically determined. An amount of the consumable may be ordered if the monitored inventory position is less than the lower inventory threshold level.

### REFERENCE TO RELATED APPLICATIONS

This application is related to U.S. patent application Ser. No. ______ (attorney docket no. 20070876-US-NP/121782.21301).

### BACKGROUND

It is common for print shops in an enterprise to experience fluctuating job demand. Due to the variability in job demand, an enterprise must maintain a certain level of inventory, such as for ink, paper or the like, in anticipation of the jobs the enterprise will receive. The appropriate inventory level is usually significant because the enterprise must maintain an inventory level necessary to process its largest jobs even if these jobs are received infrequently. As such, the costs of maintaining an appropriate inventory is usually significant as well.

When demand is independent and identically distributed, it is likely that an (s, S) policy is the optimal policy. When demand is statistically dependent from period to period, forecasting models can be employed because past demand can be used to infer future demand. When demand is statistically independent but the distribution changes over time, forecasting models cannot be employed, and an (s, S) policy applied to a variable demand distribution may produce inaccurate inventory estimates.

### SUMMARY

Before the present methods are described, it is to be understood that this invention is not limited to the particular systems, methodologies or protocols described, as these may vary. It is also to be understood that the terminology used herein is for the purpose of describing particular embodiments only, and is not intended to limit the scope of the present disclosure which will be limited only by the appended claims.

It must be noted that as used herein and in the appended claims, the singular forms “a,” “an,” and “the” include plural reference unless the context clearly dictates otherwise. Thus, for example, reference to a “consumable” is a reference to one or more consumables and equivalents thereof known to those skilled in the art, and so forth. Unless defined otherwise, all technical and scientific terms used herein have the same meanings as commonly understood by one of ordinary skill in the art. As used herein, the term “comprising” means “including, but not limited to.”

In an embodiment, a method of maintaining an inventory level of a consumable in a production environment may include monitoring an inventory position associated with a consumable in a production environment, and, based on the monitoring, identifying a plurality of window sets. Each window set may include a plurality of windows, and each window may include a portion of a historic demand distribution associated with the consumable and corresponds to a total inventory management cost. The method may also include selecting, from the plurality of window sets, the window set having the window corresponding to a lowest total inventory management cost. A lower inventory threshold level for the consumable and an upper inventory threshold level for the consumable may be automatically determined using the portion of the historic demand distribution associated with the selected window set. An amount of the consumable may be ordered if the monitored inventory position is less than the lower inventory threshold level.

In an embodiment, a method of maintaining an inventory level of a consumable in a print production environment may include monitoring an inventory position associated with a consumable in a print production environment, and based on the monitoring, identifying a plurality of window sets. Each window set may include a plurality of windows, and each window may include a portion of a historic demand distribution associated with the consumable and corresponds to a total inventory management cost. The method may also include selecting, from the plurality of window sets, the window set having the window corresponding to a lowest total inventory management cost and automatically determining a lower inventory threshold level for the consumable and an upper inventory threshold level for the consumable using the portion of the historic demand distribution associated with the window having the selected window set. An amount of the consumable equal to the difference between the upper inventory threshold and the inventory position may be ordered if the monitored inventory position is less than the lower inventory threshold level.

In an embodiment, a system of maintaining an inventory level of a consumable in a production environment may include a processor and a processor readable storage medium in communication with the processor. The processor readable storage medium may contain one or more programming instructions for monitoring an inventory position associated with a consumable in a production environment, and based on the monitoring, identifying a plurality of window sets. Each window set may include a plurality of windows. Each window may include a portion of a historic demand distribution associated with the consumable and corresponds to a total inventory management cost. The method may also include selecting, from the plurality of window sets, the window set having the window corresponding to a lowest total inventory management cost. The method may also include automatically determining a lower inventory threshold level for the consumable and an upper inventory threshold level for the consumable using the portion of the historic demand distribution associated with the selected window set, and ordering an amount of the consumable if the monitored inventory position is less than the lower inventory threshold level.

### BRIEF DESCRIPTION OF THE DRAWINGS

Aspects, features, benefits and advantages of the present invention will be apparent with regard to the following description and accompanying drawings, of which:

FIG. 1 depicts an exemplary inventory position that varies according to an (s,S) policy.

FIG. 2 depicts a flow chart of an exemplary method of maintaining an inventory level of a consumable in a production environment according to an embodiment.

FIG. 3 illustrates exemplary demand information according to an embodiment.

FIG. 4 depicts an exemplary estimated gamma distribution according to an embodiment.

FIG. 5 illustrates an exemplary graph of inventory management cost according to an embodiment.

FIG. 6 depicts exemplary distributions and corresponding inventory management costs and window sizes according to an embodiment.

FIG. 7 illustrates a block diagram of exemplary internal hardware that may be used to contain or implement program instructions according to an embodiment.

### DETAILED DESCRIPTION

For purposes of the discussion below, a “job” refers to a logical unit of work that is to be completed for a customer. A job may include one or more print jobs from one or more clients.

A “print job” refers to a job processed in a print production environment. For example, a print job may include producing credit card statements corresponding to a certain credit cared company, producing bank statements corresponding to a certain bank, printing a document, or the like. Although the disclosed embodiments pertain to print jobs, the disclosed methods and systems can be applied to jobs in general in other production environments, such as automotive manufacturing, semiconductor production and the like.

An “inventory position” is the inventory at a storage location, such as a warehouse, plus any inventory that has been ordered but not yet delivered minus inventory that is backordered.

An “inventory policy” is an analysis of costs, levels, areas of risk and the like associated with a production environment's inventory position.

A “lead time period” is the inventory replenishment time from a supplier in days.

A “consumable” is an item that is utilized by a production environment in the processing of jobs. A consumable's inventory may be depleted by the use of the consumable. In a print production environment, a consumable may include ink, paper, toner, printer components, preprinted documents, forms, envelopes, compact discs, document binders and/or the like.

A “demand distribution” includes a plurality of demand values associated with a consumable over a period of time.

A “historic demand distribution” is a distribution of past demand associated with a consumable over a period of time.

An “inventory management cost” is the aggregate of an ordering cost, a holding cost and a penalty cost.

A “reorder point” is a minimum inventory level at which a new order may be placed.

An “order-up-to level” is a base-stock inventory level maintained by a production environment.

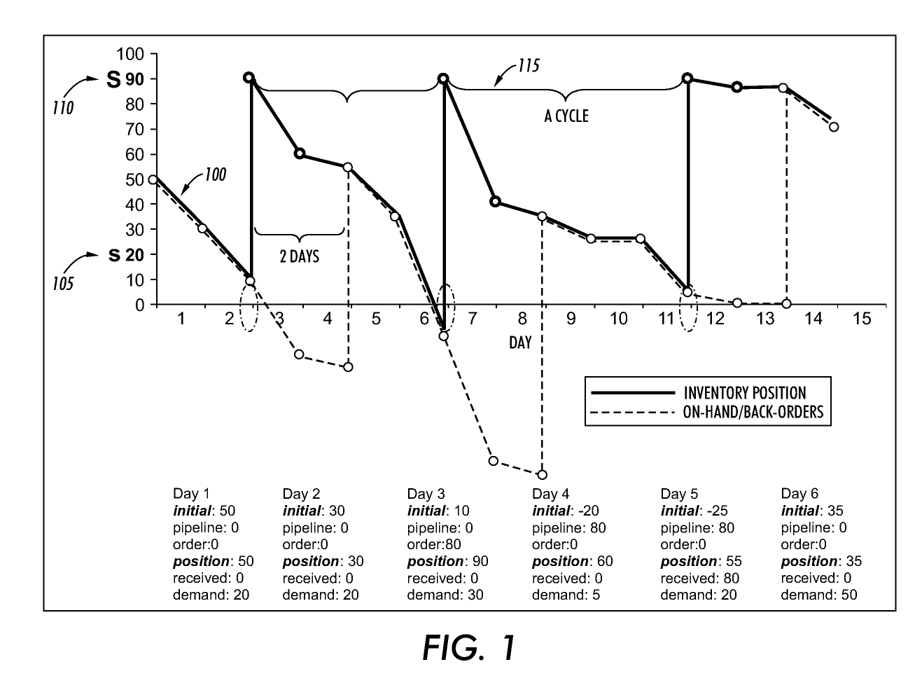

Inventory levels for a supply chain may be monitored and maintained through the use of an inventory policy, such as an (s,S) policy. An (s,S) policy compares an inventory position to a lower threshold, s. If the inventory position is less than s, then an amount of inventory is ordered to bring the inventory back to an upper threshold, S. FIG. 1 illustrates an exemplary inventory position 100 that varies according to the (s,S) policy. As illustrated, when the inventory position 100 falls below a level, s 105, an amount of inventory necessary to raise the inventory position to a level. S 110, may be ordered. A cycle 115 may be the number of days it takes the inventory position 100 to decrease from S 110 to a level that is less than s 105.

In an embodiment, the greater the value of S, the less frequently inventory may need to be reordered. However, there may be holding costs associated with maintaining a large inventory level. On the other hand, if the value of s is too high, then orders may be placed frequently. If the value of s is too low, then inventory levels may be depleted frequently.

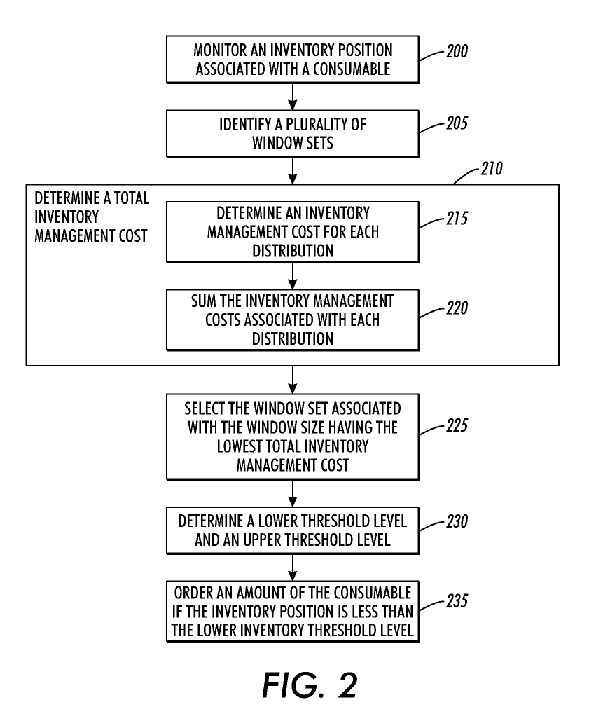

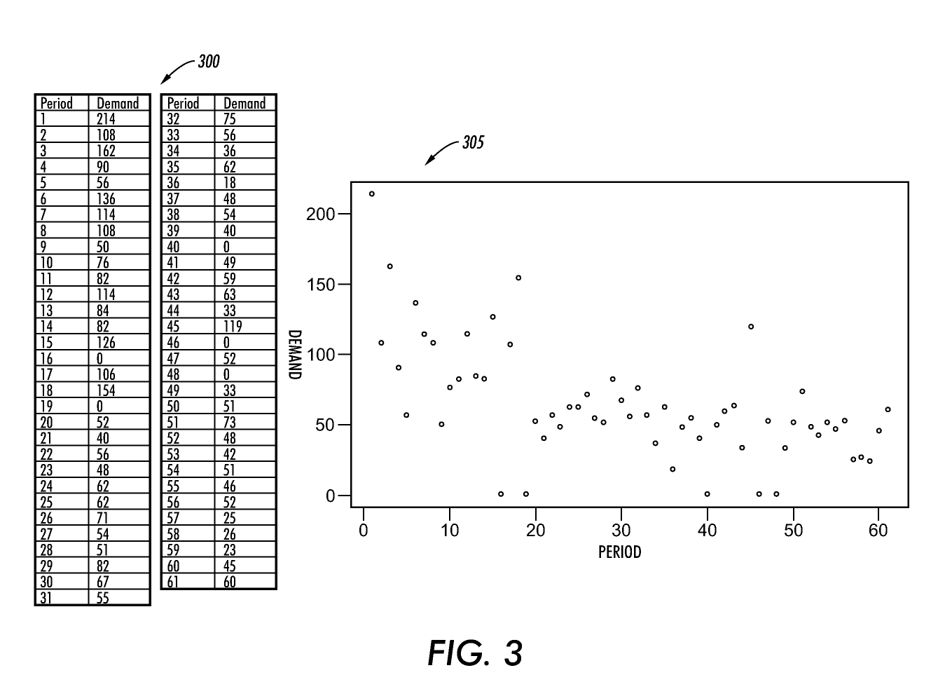

FIG. 2 illustrates a flow chart of an exemplary method of maintaining an inventory level of a consumable in a production environment according to an embodiment. An inventory position associated with a consumable may be monitored 200. In an embodiment, a historic demand distribution corresponding to the consumable may be identified. The historic demand distribution may be a distribution of past demand associated with a consumable over a period of time. For example, a historic demand distribution associated with black ink may be the distribution of demand associated with black ink over the past week, month, year or other time period. In addition, a historic demand distribution may be the distribution of demand associated with a consumable during any past time period. For example, a historic demand distribution associated with white paper may be the distribution of demand associated with white paper during a previous month. FIG. 3 illustrates exemplary demand information 300 associated with a printer drum and a corresponding plot 305 of the demand information.

In an embodiment, a plurality of window sets may be identified 205. Each set may include a plurality of windows. In an embodiment, the plurality of windows may have the same window size. Alternatively, one or more windows may have differing window sizes. Each window may include at least a portion of a historic demand distribution associated with a consumable. The historic demand distribution may be grouped into one or more subsets where each subset may be of a size equal to the window size.

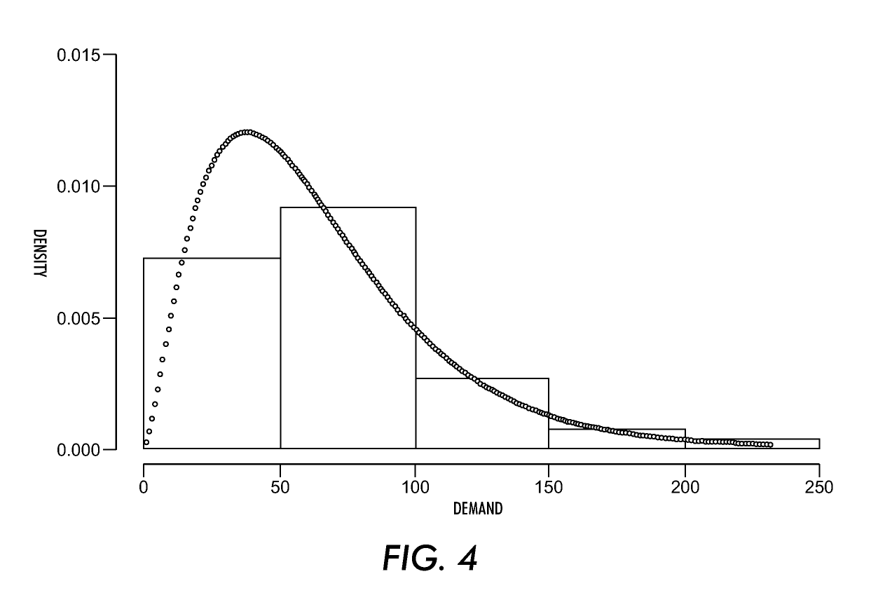

In an embodiment, a demand distribution may be estimated using one or more of the subsets. For example, if demand data in a historic demand distribution is represented by x₁, . . . , x_{N}, and a window size is m, then a demand distribution may be estimated from one or more of the following data sets: {x₁, . . . , xₘ}, {x₂, . . . , xₘ₊₁}, {xₙ, . . . , xₙ₊ₘ₋₁}. In an embodiment, a demand distribution may be estimated as a gamma distribution, an empirical distribution and/or the like. FIG. 4 illustrates an exemplary estimated gamma distribution of the demand information depicted in FIG. 3.

In an embodiment, an inventory management cost may be determined for a distribution. An inventory management cost may be, for example, the aggregate of an ordering cost, a holding cost and a penalty cost. In an embodiment, an inventory management cost may be represented by:

$$G ( y ) = h {\sum }_{l = 0}^{y} ( y - j ) {φ}_{l + 1} ( j ) + p {\sum }_{l = y}^{∞} ( j - y ) {φ}_{l + 1} ( j ) ;$$

where h is the holding cost per period,

p is the penalty cost per period,

f is the cost per order,

l is a lead time,

φ is the demand probability distribution, and

φₗ₊₁ is the probability distribution of the sum of l+1 random variables each with a distribution φ.

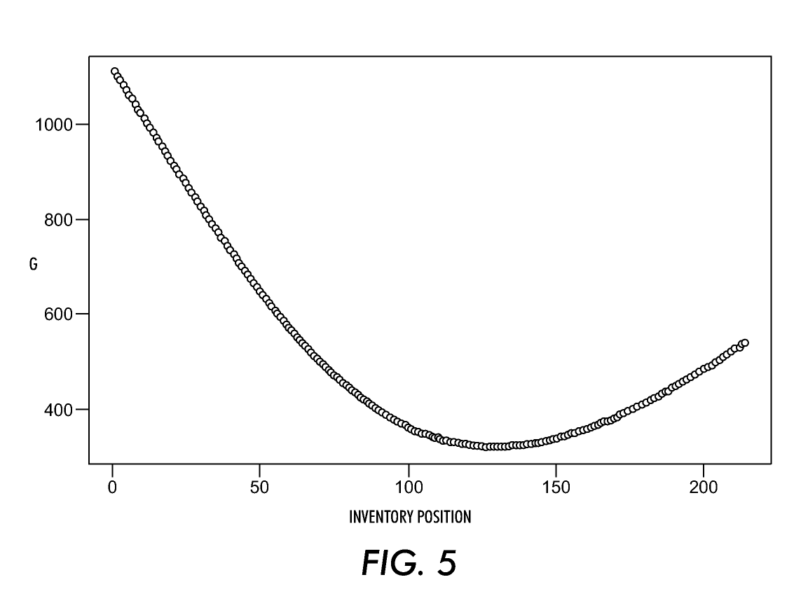

For example, FIG. 5 illustrates an exemplary graph of G(y) for the demand distribution illustrated in FIG. 4 according to an embodiment. In this example, the lead time, λ, equals 1, the hold cost, h, equals 5 and the penalty cost, p, equals 10.

In an embodiment, the ordering cost may be the total expense incurred in placing an order for the consumable. For example, the ordering cost may include labor cost associated with issuing a new order. The holding cost may be the total expense incurred in warehousing the consumable. The holding cost may include, for example, costs associated with rent, space maintenance and insurance.

In an embodiment, the penalty cost may be the total expense incurred when the inventory held by a production environment is insufficient to meet the demand. Exemplary penalty costs may include, without limitation, fines levied as part of a service level agreement and ill-will generated by not being able to satisfy an order.

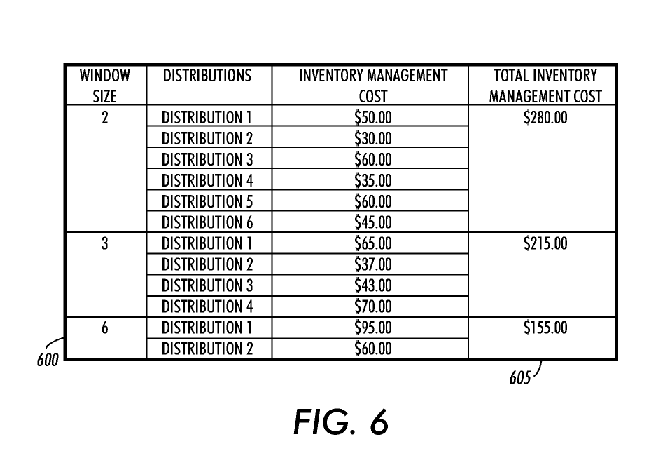

In an embodiment, a total inventory management cost may be determined 210 for each window set. A total inventory management cost may be determined 210 by determining 215 an inventory management cost for each distribution having the window size and summing 220 the inventory management costs associated with each distribution having the window size. FIG. 6 illustrates exemplary distributions and corresponding inventory management costs and window sizes according to an embodiment.

In an embodiment, the window set associated with the window size having the lowest total inventory management cost may be selected 225. For example, referring to FIG. 6, a window set corresponding to a window size of 6 600 may be selected 225 because this window size corresponds to the lowest total inventory management cost (i.e., $155.00 605).

In an embodiment, a lower inventory threshold level and an upper inventory threshold level associated with the consumable may be determined 230. These threshold levels may be determined using the historic demand associated with the selected window size. In an embodiment, the lower inventory threshold level and the upper inventory threshold level may minimize the total inventory management cost. Methods of determining lower and upper inventory threshold levels are known to those skilled in the art.

In an embodiment, the lower inventory threshold level may be a reorder point. A reorder point may be a minimum inventory level at which a new order may be placed. In an embodiment, the upper inventory threshold level may be an order-up-to level. An order-up-to level may be a base-stock inventory level maintained by a production environment. For example, an order-up-to level may represent a certain number of weeks worth of inventory associated with a production environment.

In an embodiment, the lower inventory threshold level may be less than or equal to the upper threshold level. In an embodiment, an amount of consumable may be ordered 235 if the inventory position associated with the consumable is less than the lower inventory threshold level. Alternatively, an amount of consumable may be ordered 235 if the inventory position associated with the consumable is less than or equal to the lower inventory threshold level.

In an embodiment, the amount of consumable that is ordered may be equal to the difference between the upper inventory threshold and the inventory position. For example, if the inventory position is 40, the lower inventory threshold level is 50 and the upper threshold level is 75, an order for 35 units (i.e., 75−40) of consumable may be placed because the inventory position (i.e., 40) is less than the lower inventory threshold (i.e., 50). In an alternate embodiment, the amount of consumable that is ordered may exceed the difference between the upper inventory threshold and the inventory position.

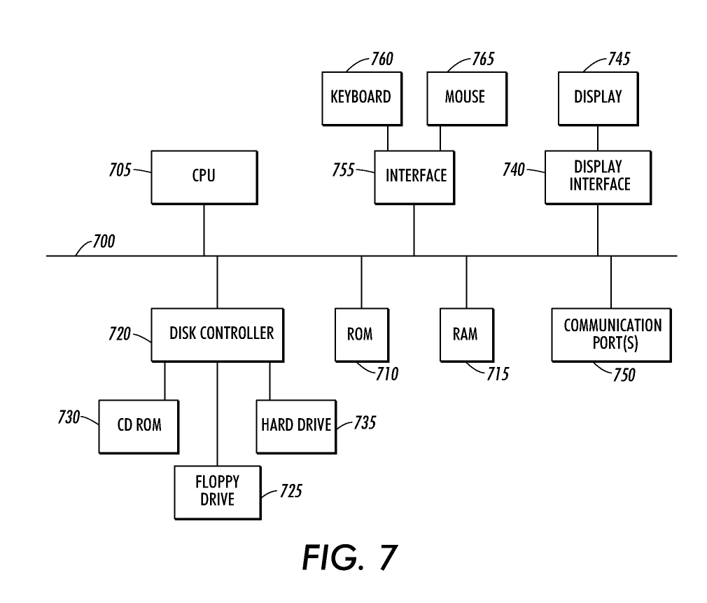

FIG. 7 depicts a block diagram of exemplary internal hardware that may be used to contain or implement program instructions according to an embodiment. A bus 700 serves as the main information highway interconnecting the other illustrated components of the hardware. CPU 705 is the central processing unit of the system, performing calculations and logic operations required to execute a program. Read only memory (ROM) 710 and random access memory (RAM) 715 constitute exemplary memory devices.

A disk controller 720 interfaces with one or more optional disk drives to the system bus 700. These disk drives may include, for example, external or internal DVD drives 725, CD ROM drives 730 or hard drives 735. As indicated previously, these various disk drives and disk controllers are optional devices.

Program instructions may be stored in the ROM 710 and/or the RAM 715. Optionally, program instructions may be stored on a tangible computer readable medium such as a compact disk, a digital disk or other recording medium.

An optional display interface 740 may permit information from the bus 700 to be displayed on the display 745 in audio, graphic or alphanumeric format. Communication with external devices may occur using various communication ports 750. An exemplary communication port 750 may be attached to a communications network, such as the Internet or an intranet.

In addition to the standard computer-type components, the hardware may also include an interface 755 which allows for receipt of data from input devices such as a keyboard 760 or other input device 765 such as a mouse, a touch screen, a remote control, a pointer and/or a joystick.

An embedded system, such as a sub-system within a xerographic apparatus, may optionally be used to perform one, some or all of the operations described herein. Likewise, a multiprocessor system may optionally be used to perform one, some or all of the operations described herein.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A method of maintaining an inventory level of a consumable in a production environment, the method comprising:
monitoring an inventory position associated with a consumable in a production environment;
based on the monitoring, identifying a plurality of window sets, wherein each window set comprises a plurality of windows, and wherein each window comprises a portion of a historic demand distribution associated with the consumable and corresponds to a total inventory management cost;
selecting, from the plurality of window sets, the window set having the window corresponding to a lowest total inventory management cost;
automatically determining a lower inventory threshold level for the consumable and an upper inventory threshold level for the consumable using the portion of the historic demand distribution associated with the selected window set; and
ordering an amount of the consumable if the monitored inventory position is less than the lower inventory threshold level.

2. The method of claim 1, wherein identifying a plurality of window sets comprises identifying at least one window set having a plurality of windows that are of equal size.

3. The method of claim 1, wherein selecting the window set comprises:
for each of the plurality of window sets:
estimating one or more demand distributions using one or more subsets of the historical demand distribution, wherein each subset is of a size equal to the window size,
determining, for each demand distribution, an inventory management cost, and
determining a total inventory management cost by summing the inventory management cost associated with each demand distribution; and
selecting, from the plurality of window sets, the window set associated with the lowest total inventory management cost.

4. The method of claim 3, wherein estimating one or more demand distributions comprises estimating one or more of a gamma distribution and an empirical distribution.

5. The method of claim 3, wherein determining, for each demand distribution, an inventory management cost comprises:
determining a sum of a fixed ordering cost, a holding cost and a penalty cost associated with the demand distribution.

6. The method of claim 1, wherein ordering an amount of the consumable comprises:
ordering an amount of the consumable equal to a difference between the upper inventory threshold and the monitored inventory position.

7. The method of claim 1, wherein ordering an amount of the consumable comprises:
ordering an amount of the consumable that exceeds a difference between the upper inventory threshold and the monitored inventory position.

8. The method of claim 1, wherein monitoring an inventory position associated with a consumable in a production environment comprises monitoring an inventory position associated with one or more of the following:
ink;
paper;
toner;
one or more printer components;
one or more preprinted documents;
one or more forms;
one or more envelopes;
one or more compact discs; and
one or more document binders.

9. A method of maintaining an inventory level of a consumable in a print production environment, the method comprising:
monitoring an inventory position associated with a consumable in a print production environment;
based on the monitoring, identifying a plurality of window sets, wherein each window set comprises a plurality of windows, wherein each window comprises a portion of a historic demand distribution associated with the consumable and corresponds to a total inventory management cost;
selecting, from the plurality of window sets, the window set having the window corresponding to a lowest total inventory management cost;
automatically determining a lower inventory threshold level for the consumable and an upper inventory threshold level for the consumable using the portion of the historic demand distribution associated with the window having the selected window set; and
ordering an amount of the consumable equal to the difference between the upper inventory threshold and the inventory position if the monitored inventory position is less than the lower inventory threshold level.

10. The method of claim 9, wherein identifying a plurality of window sets comprises identifying at least one window set having a plurality of windows that are of equal size.

11. The method of claim 9, wherein selecting the window set comprises:
for each of the plurality of window sets:
estimating one or more demand distributions using one or more subsets of the historical demand distribution, wherein each subset is of a size equal to the window size,
determining, for each demand distribution, an inventory management cost, and
determining a total inventory management cost by summing the inventory management cost associated with each demand distribution; and
selecting from the plurality of window sets, the window set having a size associated with the lowest total inventory management cost.

12. The method of claim 11, wherein estimating one or more demand distributions comprises estimating one or more of a gamma distribution and an empirical distribution.

13. The method of claim 9, wherein monitoring an inventory position comprises monitoring an inventory position associated with one or more of the following:
ink;
paper;
toner;
one or more printer components;
one or more preprinted documents;
one or more forms;
one or more envelopes;
one or more compact discs; and
one or more document binders.

14. A system of maintaining an inventory level of a consumable in a production environment, the system comprising:
a processor; and
a processor readable storage medium in communication with the processor,
wherein the processor readable storage medium contains one or more programming instructions for:
monitoring an inventory position associated with a consumable in a production environment;
based on the monitoring, identifying a plurality of window sets, wherein each window set comprises a plurality of windows, and wherein each window comprises a portion of a historic demand distribution associated with the consumable and corresponds to a total inventory management cost;
selecting, from the plurality of window sets, the window set having the window corresponding to a lowest total inventory management cost;
automatically determining a lower inventory threshold level for the consumable and an upper inventory threshold level for the consumable using the portion of the historic demand distribution associated with the selected window set; and
ordering an amount of the consumable if the monitored inventory position is less than the lower inventory threshold level.

15. The system of claim 14, wherein the one or more programming instructions for selecting the window set comprises one or more programming instructions for:
for each of the plurality of window sets:
estimating one or more demand distributions using one or more subsets of the historical demand distribution, wherein each subset is of a size equal to the window size,
determining, for each demand distribution, an inventory management cost, and
determining a total inventory management cost by summing the inventory management cost associated with each demand distribution; and
selecting from the plurality of window sets, the window set associated with the lowest total inventory management cost.

16. The system of claim 14, wherein the one or more programming instructions for determining, for each demand distribution, an inventory management cost comprises one or more programming instructions for determining a sum of a fixed ordering cost, a holding cost and a penalty cost associated with the demand distribution.

17. The system of claim 14, wherein the one or more programming instructions for ordering an amount of the consumable comprises one or more programming instructions for ordering an amount of the consumable equal to a difference between the upper inventory threshold and the inventory position.

18. The system of claim 14, wherein the one or more programming instructions for ordering an amount of the consumable comprises one or more programming instructions for ordering an amount of the consumable that exceeds a difference between the upper inventory threshold and the inventory position.

19. The system of claim 14, wherein the one or more programming instructions for monitoring an inventory position comprises one or more programming instructions for monitoring an inventory position associated with one or more of the following:
ink;
paper;
toner;
one or more printer components;
one or more preprinted documents;
one or more forms;
one or more envelopes;
one or more compact discs; and
one or more document binders.
